(19) United States
(12) Patent Application Publication
(10) Pub. No.: US 2008/0293839 A1
(43) Pub. Date: Nov. 27, 2008

(54) STABILIZED EXTRUDED ALKENYL AROMATIC POLYMER FOAMS AND PROCESSES FOR EXTRUDING STABILIZED ALKENYL AROMATIC POLYMER FOAMS

(76) Inventor: William G. Stobby, Midland, MI (US)

Correspondence Address: The Dow Chemical Company, Intellectual Property Section, P.O. Box 1967, Midland, MI, 48641-1967, US

(21) Appl. No.: 12/033,028

(22) Filed: Feb. 19, 2008

Related U.S. Application Data
(63) Continuation-in-part of application No. 11/897,800, filed on Aug. 31, 2007, now abandoned.
(60) Provisional application No. 60/842,819, filed on Sep. 7, 2006.

(51) Int. Cl. C08J 9/00; C08K 5/1515; C08K 5/13

(52) U.S. Cl. 521/81; 521/79; 521/189; 521/181

(57) ABSTRACT

Prepare an extruded thermoplastic polymer foam having a thermoplastic polymer composition having defined therein multiple cells, the thermoplastic polymer foam containing at least one thermoplastic polymer, a brominated flame retardant, an epoxy containing organic compound and 180 weight parts or less of water extractable cations using a brominated flame retardant, an innocuous stabilizer and a blowing agent containing water.

### CROSS REFERENCE STATEMENT

This is a Continuation-in-Part application of U.S. application Ser. No. 11/897,800 filed Aug. 31, 2007 which claims benefit of U.S. Provisional Application No. 60/842,819, filed Sep. 7, 2006.

### FIELD OF THE INVENTION

The invention relates to stabilized extruded alkenyl aromatic polymer foams and to processes for extruding stabilized alkenyl aromatic polymer foams.

### BACKGROUND OF THE INVENTION

In 2010, emissions standards in the United States and in Europe are expected to become more stringent. One area that will be affected by these new standards is the production of alkenyl aromatic polymer foams and the resulting foam products. Such foams, as well as the processes for making them, must comply with these standards while also complying with flame retardant related standards and thermal conductivity requirements with respect to insulation applications. One aspect of producing foams that will be particularly affected is the selection of a blowing agent. To comply with emission standards, many of the blowing agents that are currently used, particularly hydrochlorofluorocarbons (HCFCs) will likely not be available. Therefore, substitutions or replacements for these compounds in blowing agents will be required. The most desirable blowing agent systems would comprise a substantial amount of water and/or carbon dioxide (CO₂).

Flame retardants are necessary additives in the production of alkenyl aromatic polymer foams in order to produce foams that pass required fire standards. These flame retardants have typically contained bromine. Hexabromocyclododecane (HBCD) is generally used in the extruded polystyrene foam industry because it has the most favorable combination of cost and performance for flame retardant additives currently available.

In addition to brominated flame retardants, stabilizers are also typically employed to protect the flame retardants from extensive decomposition during the extrusion process by which extruded foam is made.

It is desirable to prepare a quality extruded polymeric foam using a brominated flame retardant in combination with water as a blowing agent component and in order to obtain a foam using an environmentally friendly blowing agent and that achieves necessary flame retardant properties.

### SUMMARY OF THE INVENTION

This invention is the result of discovering that extrusion processes for thermoplastic polymer foam using water as a blowing agent, a brominated flame retardant and conventional stabilizers develop problems with surface defects on the foam as it exits the extrusion die. Such surface defects take the form of lines, cuts, fractures or other irregularities extending in the extrusion direction along a primary surface of the foam. Such surface defects are undesirable. Research in developing the present invention required discovering the cause for these surface defects and discovering a method for avoiding them.

The surface defects were unexpectedly and surprisingly found to result from build-up of salts from water extractable cations that, under the conditions at the extrusion die lip, are in a solid state and less malleable than the expanding polymer. Analysis of the salts revealed that they tend to be reaction byproducts of brominated flame retardants and conventional inorganic based flame retardant stabilizers (such as tetrasodium pyrophosphate, magnesium oxide, sodium zeolite A and alkali stearates) in the presence of water. The water extractable cations are carried to the die lip by water. The water flashes off at the die lip leaving the salts behind. The salts then cut into the foam surface thereby creating defect on the foam surface as the foam exits the die lip. Notably, the problem does not appear to exist unless water is present in the foamable composition presumably because the water extractable cations have no carrier means to transfer them to the die lip.

The present invention provides a novel and inventive solution to the problem of surface defects in extruded foam caused by the previously unexpected build up of salts from water extractable cations on the die lip of the extrusion equipment.

In a first aspect, the present invention is a process for extruding a thermoplastic polymer foam comprising the steps of: (a) providing a foamable composition comprising a thermoplastic polymer, a blowing agent that includes water, a brominated flame retardant and a stabilizer in an extrusion die at an initial temperature that exceeds the softening point of the thermoplastic polymer and at an initial pressure sufficient to preclude foaming; (b) extruding the foamable composition through an extrusion die and out from an extrusion die lip to an environment at a pressure and temperature lower than the initial temperature and pressure; and (c) allowing the foamable composition to expand into a polymeric foam; wherein the foamable composition contains 180 weight parts or less of water extractable cations.

Particular embodiments of the first aspect include one or any combination of more than one of the following additional characteristics: the foamable composition contains 200 weight parts or less free bromide ion per million weight parts of foamable composition; the foamable composition contains water extractable Group 2A cations and the concentration of water extractable Group 2A cations is 150 weight parts or less, where weight parts are based on total thermoplastic polymer weight, and the water extractable Group 2A cations account for 80% or more by weight of all water extractable cations in the foamable composition; at least 50 percent by weight of the stabilizer is one or more stabilizer selected from a group consisting of innocuous epoxy containing organic compounds, innocuous allylophilic organotin compounds and innocuous dieneophilic organotin compounds; at least 50 percent by weight of the stabilizer is one or more innocuous epoxy containing organic compound, desirably epoxy cresol novolac; at least 80 percent by weight of the stabilizer is one or more innocuous epoxy containing organic compound; the stabilizer is one or more innocuous epoxy containing organic compound; the stabilizer is present at concentration of 30 weight-percent or less based on brominated flame retardant weight; the concentration of water is at least 0.15 parts per hundred based on polymer weight; and the thermoplastic polymer comprises one or a combination of more than one alkenyl aromatic polymer.

In a second aspect, the present invention is an extruded thermoplastic polymer foam comprising a thermoplastic polymer composition having defined therein multiple cells, the thermoplastic polymer foam containing at least one thermoplastic polymer, a brominated flame retardant, an epoxy containing organic compound and 180 weight parts or less of water extractable cations.

Particular embodiments of the second aspect include one or any combination of more than one of the following additional characteristics: the organo-epoxy containing compound is epoxy cresol novolac; the polymer foam further contains less than 200 weight parts free bromide per million weight parts of polymer foam; and the thermoplastic polymer comprises one or a combination of more than one alkenyl aromatic polymer.

The invention is useful for preparing extruded thermoplastic foams containing brominated flame retardant using water as a blowing agent. In particular, the invention is useful for preparing such an extruded thermoplastic foam that has a defect-free surface and that contains brominated flame retardant using water as a blowing agent.

### DETAILED DESCRIPTION OF THE INVENTION

“Stabilizer” refers to a compound that inhibits accelerated decomposition of a flame retardant. Brominated flame retardants having a β-hydrogen tend to decompose at elevated temperatures by evolution of hydrobromic acid (HBr) and formation of a double bond between adjoining carbon atoms. Once a double bond is present, loss of subsequent HBr molecules can be accelerated by the presence of acid as well as any propensity for the flame retardant to develop conjugated double bonds. A stabilizer counteracts the effect of the HBr, the flame retardant's propensity to form conjugated double bonds, or both.

“Softening point” of a polymer refers to the temperature at which the polymer may be extruded and blended with other components. Typically, the softening point of an amorphous polymer is at or about its glass transition temperature (Tg). The softening point of a crystalline, or semi-crystalline polymer is typically at or about its melt temperature (Tm).

A “water soluble” salt has a solubility in water of at least 0.5 percent by weight (wt %) at 20° C., meaning at least half of one gram of salt will dissolve in 100 grams of water. Even more troublesome are water soluble salts having a water solubility of at least one wt % at 20° C.

“Die lip” refers to the portion of a die channel at the exit opening. In an extrusion die, the die lip is the last portion of the die that a polymer composition contacts prior to exiting a die. Die lip and extrusion die lip are interchangeable herein.

“Die approach” refers to a portion of a die channel just prior to the die lip. The die channel is the portion of the die through with foamable composition travels during extrusion.

“Malleable” refers to the ability of a material to deform under pressure.

Group 1A cations refers to cations of elements in the Group 1A column of the periodic table of elements, other than hydrogen cations.

Group 2A cations refers to cations of the elements in the Group 2A column of the periodic table of elements.

Unless otherwise stated “pph” refers to “weight parts based on 100 weight parts polymer.”

Suitable thermoplastic polymers for use in the present invention include one or a combination of more than one alkenyl aromatic polymer and/or copolymer, ethylene-based polymer and/or copolymers, propylene based polymer and/or copolymer, and polyvinyl chloride based polymer and/or copolymer.

Desirably, the thermoplastic polymer is or contains at least one alkenyl aromatic polymer, alkenyl aromatic copolymer or blend of at least one alkenyl aromatic polymer and at least one alkenyl aromatic copolymer. A preferred such alkenyl aromatic polymer is polystyrene and preferred alkenyl aromatic copolymers are copolymers of styrene with acrylonitrile, maleic anhydride, acrylic or methacrylic acid or the alkyl esters thereof, including 2-hydroxyethyl acrylate or methacrylate. Copolymers of styrene and acrylonitrile and blends of these copolymers and blends of these copolymers with polystyrene are particularly preferred.

The brominated flame retardant can be aliphatic or aromatic. Aliphatic bromine compounds are preferred over aromatic bromine compounds because the aromatic bromine compounds are often too stable to degrade in a temperature range necessary to be optimal flame retardants in polymer foams. Aliphatic bromine compounds tend to have sufficient stability to survive an extrusion process, but degrade at a sufficiently low temperature to behave as a flame retardants in polymer foams. Examples of preferred compounds include cycloaliphatic bromine compounds such as hexabromocyclododecane (HBCD) (e.g. CD-75P, commercially available from Chemtura Corp.); hexabromo-2-butene; 1,1,1,3-tetrabromononane; tetrabromocyclooctane (BC-48, commercially available from Albemarle Corporation); 1,2-dibromo-4-(1,2-dibromoethyl)cyclohexane; dibromoethyldibromocyclohexane (BCL-462, commercially available from Albemarle Corporation); dibromomethyl dibromocyclopentane; pentabromomonochlorocyclohexane (FR-651A); hexabromocyclohexane; and, tetrabromotrichlorocyclohexane and other aliphatic compounds such as 8,9,11,12,14,15-hexabromostearic acid or 2,3-dibromopropyl functionalized compounds such as tris(2,3-dibromopropyl) isocyanurate (FR-930 from Akzo Nobel); tetrabromobisphenol S bis(2,3-dibromopropyl ether) (Normen 52 from Marubishi Oil Co.); bis(2,3-dibromopropyl ether) of tetrabromobisphenol A (PE-68 from Chemtura Corp.), and the like. Other examples of aliphatic flame retardants include the halogenated phosphate esters exemplified by tris(tribromoneopentyl) phosphate (PB-370), dibromoneopentylglycol, and tribromoneopentylalcohol, and ethylene bis(dibromomonoborane) dicarboximide (BN-451).

Another preferred brominated flame retardant comprises a thermally stable brominated copolymer, the copolymer having polymerized therein a butadiene moiety and a vinyl aromatic monomer moiety, the copolymer having, prior to bromination, a vinyl aromatic monomer content of from 5 wt % to 90 wt %, based upon copolymer weight, a 1,2-butadiene isomer content of greater than 0 wt %, based upon butadiene moiety weight, and a weight average molecular weight of at least 1000, the brominated copolymer having an unbrominated, non-aromatic double bond content of less than 50 percent, based upon non-aromatic double bond content of the copolymer prior to bromination as determined by ¹H NMR spectroscopy and a five percent weight loss temperature (5% WLT), as determined by thermogravimetric analysis (TGA) of at least 200 degrees centigrade (° C.). These brominated copolymers are described in U.S. Provisional Application No. 60/735,361, filed on Nov. 12, 2005, which is herein incorporated by reference in its entirety.

The brominated flame retardants are typically present in an amount of at least 0.2 pph, preferably at least 0.35 pph and more preferably at least 0.8 pph, preferably up to 1.2 pph and more preferably up to 4 pph.

The blowing agent for use in the present invention comprises water and desirably at least one blowing agent selected from hydrocarbons, hydrofluorocarbons and fluorocarbons. Water is typically present in an amount greater than 0.15 pph, preferably greater than 0.5 pph, more preferably greater than 0.7 pph and still more preferably greater than 1.0 pph, and typically present at a concentration up to an amount of 5 pph, preferably up to 2.5 pph and more preferably up to 1.6 pph. The use of water in the present invention allows lower process pressures, lower foam density, and larger cell size all while being an environmentally friendly blowing agent. Suitable hydrocarbons include, but are not necessarily limited to, hydrocarbons having from one to five carbons (“C₁₋₅ hydrocarbons”). The hydrocarbon is preferably selected from the group consisting of isobutane, cyclopentane, n-pentane, isopentane and combinations thereof. Other useful co-blowing agents include but are not limited to ethers having from two to five carbons, alcohols, alkyl formates and ketones. Suitable hydrofluorocarbons may include any hydrofluorocarbon, but are preferably selected from the group consisting of 1,1,1,2-tetralfluoroethane (HFC-134a); HFC-235fa; 1,1,1,3,3-pentafluoropropane (HFC-245fa); 1,1,1,3,3-pentafluorobutane (HFC-365mfc); 1,1-difluoroethane (HFC-152a) and combinations thereof. The hydrocarbon is typically present in an amount up to 6 pph, preferably in an amount up to 4 pph, and more preferably in an amount up to 2 pph. The hydrofluorocarbon is typically present in the range of from 0 pph to 10 pph, preferably in the range of from 2.0 pph to 8 pph, and more preferably in the range of from 3.0 pph to 7.5 pph. Other suitable components for the blowing agent include carbon dioxide and ethanol.

Blowing agent is typically present at a concentration of at least 0.05 moles, preferably at least 0.07 moles and typically 0.2 moles or less, preferably 0.16 moles per 100 grams of polymer.

“Water extractable cations” are cations that are present in an aqueous phase when extracted from a sample according the following procedure. To measure water extractable cations first provide a 0.05-0.5 gram polymer sample (for example, a portion of polymer foam or a sample for evaluating whether a stabilizer is “innocuous” or not (see below)). Dissolve the polymer sample into 20 milliliters (ml) of methylene chloride. Add 20 ml of deionized water and shake the mixture for 20 minutes. Allow the mixture to stand for 30 minutes. Draw a 10-15 ml portion of the water layer and filter at 0.45 micron using a syringe filter. Discard the first two ml of filtered water layer. Analyze the remaining filtered aqueous layer using inductively coupled plasma emissions spectrometry (ICP) to identify and quantify the water extractable cations obtained by this extraction method.

“Free bromide” refers to ion analysis conducted on a polymer sample material using the following procedure Provide a 0.05-0.5 gram polymer sample (for example, a portion of polymer foam or a sample for evaluating whether a stabilizer is “innocuous” or not (see below)). Dissolve the polymer sample into 20 milliliters (ml) of methylene chloride. Add 20 ml of deionized water and shake the mixture for 20 minutes. Allow the mixture to stand for 30 minutes. Draw a 10-15 ml portion of the water layer and filter at 0.45 micron using a syringe filter. Discard the first two ml of filtered water layer. Inject 50 microliters of the remaining filtered water portion onto a Dionex IonPac/AS4 anion exchange column (50/250×4 mm ID) while eluting with 2.0 millimole (mM) Na₂CO₂/2.0 mM NaHCO₃ solution at 2.0 ml per minute at approximately 1000 pounds per square inch. Use a conductivity detector at 3 μS as an analyzer to measure bromide. Integrate the detection signal using a Spectra-Physics 4400 integrator. Calibrate against standard solutions of known bromide concentration.

“Innocuous stabilizer” refers to a stabilizer that does not produce a significant amount of water extractable cations present in a foamable composition containing barium stearate and hexabromomcyclododecane (HBCD). Determine whether a stabilizer is an “innocuous stabilizer” by combining 0.1 weight parts stabilizer, one weight part HBCD and 0.25 weight parts barium stearate with 100 weight parts polystyrene in a Haake mixing bowl at 200° C. and 40 revolutions per minute for eight minutes under a nitrogen purge to form a polymer sample. Analyze the polymer sample for water extractable cations. If the total amount of water extractable cations is 180 weight parts or less, the barium cation concentration is 150 weight parts or less per one million weight parts polystyrene and the concentration of barium cation accounts for at least 80% by weight of the total water extractable cations then the stabilizer is an “innocuous stabilizer”. Desirably, the polymer sample has 150 weight parts or less, preferably 100 weight parts or less, still more preferably 80 weight parts or less cations per one million weight parts polystyrene. Additionally, the polymer sample desirably has 100 weight parts or less, preferably 75 weight parts or less, still more preferably 50 weight parts or less barium cations per one million weight parts polystyrene.

Innocuous stabilizers include innocuous acid scavengers. Innocuous acid scavengers stabilize brominated flame retardants by reacting with acids that may catalyze the decomposition of the brominated flame retardant. For example, an innocuous acid scavenger reacts with HBr byproduct from decomposition of a brominated flame retardant thereby interfering with the ability of the HBr to catalyze further decomposition of the brominated flame retardant.

The most desirable innocuous acid scavenger is an epoxy containing organic compound (“organo-epoxy” stabilizer). Examples of organo-epoxy stabilizers include non-brominated novolac based epoxy resins such as Araldite ECN-1273 or ECN-1280, (Huntsman Advance Materials Americas, Inc.); and aliphatic epoxy materials including propylene oxide and aliphatic based epoxy resins, for example, Plaschek 775 aliphatic epoxy resin (Ferro Chemical Co). Propylene oxide offers the advantage of being soluble in the water and offers the potential to neutralize any water extracted hydrobromic acid. One particularly desirable organo-epoxy innocuous acid scavenger is epoxy cresol novolac.

Brominated aromatic epoxy resins are particularly desirable due to their low plasticization potential. Examples of such resins include, but are not limited to, epoxy resins based on tetrabromobisphenol A, such as F2200HM (ICL Industrial Products) and DEN 439 (The Dow Chemical Co.). Organo-epoxy innocuous acid scavenger compounds are typically present in an amount up to 30 wt %, preferably in an amount up to 15 wt %, and more preferably in an amount up to 8 wt % based on the weight of the halogenated flame retardant. Desirably, if present, the organic acid scavengers are present at a concentration of at least one wt % based on the weight of the halogenated flame retardant. Moreover, organo-epoxy innocuous acid scavenger compounds desirably account for at least 50% by weight, more preferably at least 75% by weight and can account for 100% by weight of the total weight of stabilizer in a polymer composition or polymer foam of the present invention.

In addition to an organo-epoxy stabilizer, or as an alternative to the organo-epoxy stabilizer, the polymer composition may contain an organotin innocuous stabilizer. Suitable organotin stabilizers are described in Chapter 3.2.2.1 of the Plastic Additives Handbook, 5^{th} Edition, edited by H. Zweifel (incorporated herein by reference). Organotin stabilizers suitable for use in the present invention fall into two categories: innocuous allylophilic organotin compounds and innocuous dieneophilic organotin compounds. Allylophilic organotin stabilizers stabilize brominated flame retardants from accelerated decomposition by reacting with allyl functionalities that form when a brominated flame retardant loses HBr. By reacting with the allyl functionality, the propensity for the flame retardant to lose additional HBr to obtain conjugation is eliminated. Similarly, dienophilic organotin stabilizers react by means of a Diels Alder reaction with dienes formed when a brominated flame retardant loses two adjacent HBr to form a conjugated diene. By reacting with the diene functionality, the propensity for the flame retardant to lose additional HBr to obtain further conjugation is eliminated.

Examples of suitable organotin stabilizers include organotin compounds selected from a group consisting of alkyl tin thioglycolates, alkyl tin mercaptopropionates, alkyl tin mercaptides, alkyl tin maleates and alkyl tin di(alkylmaleates) wherein the alkyls are selected from methyl-, butyl- and octyl-groups. Commercial examples of such compounds include Thermchek® 832 (Ferro Corporation) and Thermolite 400 (Arkema Inc.), Baerostab M36 (Baerlocher GmbH). The amount of organotin stabilizer is typically in the range of from 0.1 wt % to 10 wt %, preferably 1 wt % to 3 wt %, and more preferably in the range of from 1.5 wt % to 2.5 wt % based on the weight of halogenated flame retardant. Desirably, 50% or more by weight of total stabilizer is one or more stabilizer selected from a group consisting of innocuous epoxy containing organic compounds, innocuous allylophilic organotin compounds and innocuous dieneophilic compounds.

Of particular surprise, organo-epoxy stabilizers and organotin stabilizers at levels greater than or equal to 1.0 wt % in the halogenated flame retardant have been shown in the present invention to allow use of barium stearate without undesirable buildup of barium bromide salts on the die face at an extruder discharge foamable composition temperature around 220° C. The terms “undesirable buildup” or “exhibiting buildup” generally mean buildup of a compound on an extrusion die such that it interferes with the skin quality of the resulting foam. Lower levels of organo-epoxy stabilizers and organotin stabilizers may have similar surprising results at lower process temperatures.

Anti-oxidant and/or chelant materials may be added as separate components, or as one component that serves as both anti-oxidant and chelant. Anti-oxidants and chelants also qualify as innocuous stabilizers but, if included in the present invention, are used in combination with at least one innocuous acid scavenges, innocuous allylophilic organotin compound and/or innocuous dieneophilic organotin compound. Suitable anti-oxidants are described in Chapter 1.5 of the Plastic Additives Handbook, 5^{th} Edition, edited by H. Zweifel (incorporated herein by reference). Examples of suitable anti-oxidant compounds include, but are not necessarily limited to, the class of phenol based anti-oxidants, also described as hindered phenol anti-oxidants, examples of such are Irganox 1010 and Irganox 1076 (Ciba Specialty Chemicals). Examples of suitable chelants include, but are not necessarily limited to a class of compounds described as 1,2-dicarbalkoxyhydrazine with an example being 1,2-dicarbethoxyhydrazine (CAS# 4114-28-7). Another class is based on N-substituted derivatives of oxamide (CAS# 471-46-5) with an example being 2,2′-oxamido bis-(2-hydroxyethyl). Examples of one component anti-oxidant/chelants include, but are not necessarily limited to, compounds such as Naugard XL-1 (2,2′-oxamidobis-[ethyl 3-(3,5-di-tert-butyl-4-hydroxyphenyl)propionate]) (Chemtura Corp.) and Irganox MD 1024 (1,2-bis(3,5-di-tert-butyl-4-hydroxyhydrocinnamoyl) hydrazine, Ciba Specialty Chemicals). These components are present in amounts up to 5 wt %, preferably in an amount up to 3 wt %, and more preferably in an amount up to 2.5 wt % based on weight of halogenated flame retardant. Preferably, these components are present in amounts of at least 0.5 wt % and more preferably at least 1.0 wt %, based on weight of halogenated flame retardant. Not wishing to be bound by any particular theory, it is believed that the anti-oxidant prevents oxygen induced degradation of the halogenated flame retardant in the extruder and chelants complexes or traps transition metal ions that are byproducts of corrosion of the metal surfaces of the extrusion system resulting from the hydrogen halide evolution from the halogenated flame retardant.

The composition may further comprise extruder lubricants. In particular, the composition may comprise metal stearates, preferably calcium or barium stearate.

Other common additives may be included in the present invention, including but not limited to, UV stabilizers, metal stabilizers, pigments, nucleating agents, internal process lubricates, plasticizers and IR blockers.

Notably, foamable compositions and foams within the scope of the present invention desirably contain less than 0.1 pph, preferably 0.05 pph or less, more preferably 0.01 pph or less and most preferably are free of hydrotalcite compounds. Experimentation has shown that foamable compositions containing 0.1 pph or more, even 0.05 pph or more hydrotalcite result in undesirable build up of salts from water extractable cations on the die lip, which leads to manufacture of polymer foam having poor skin quality. (See, for example, Comparative Example B).

In a conventional extrusion foaming process, polymer components are converted into a polymer melt and a blowing agent, and, if desired, other additives are incorporated into the polymer melt to form a foamable composition. Those of skill in the art understand that the physical properties and the amount of the additive dictate whether the additive can be added directly or needs to first be compacted or compounded and then added. In many cases it is preferred to pre-compound as much of the stabilizer package as possible into a polymer concentrate or compacted particle and then add the material to ensure intimate mixing of all of the additives with the brominated flame retardant. The foamable composition is then extruded through a die and into a zone of reduced or lower pressure that promotes foaming to form a desired product. The reduced pressure is lower than that under which the foamable composition is maintained prior to extrusion through the die. The lower pressure may be atmospheric, superatmospheric or subatmospheric (vacuum), but is preferably at an atmospheric level. A subsequent post-extrusion step to further reduce density is optional, for example, as is taught in EP0268805 (incorporated herein by reference).

Before extruding foamable composition through a die, it is typically cooled from a temperature that promotes melt mixing to a lower, optimum foaming temperature. The foamable composition may be cooled in the extruder or other mixing device or in separate coolers. The optimum foaming temperature typically exceeds the glass transition temperature (T_{g}) of each polymer component. “Near” means at, above, or below and largely depends upon where stable foam exists. The temperature desirably falls within 40° C. above the T_{g}. For foams of the present invention, an optimum foaming temperature can be determined by simple experimentation by one skilled in the art to produce the desired foam with the appropriate density and open cell content.

The blowing agent may be incorporated or mixed into the polymer melt by any means known in the art such as with an extruder, mixer, or blender. The blowing agent is mixed with the polymer melt at an elevated pressure sufficient to prevent substantial expansion of the melt polymer material and to generally disperse the blowing agent homogeneously therein. Water-soluble stabilizers of the invention may be added to the water prior to addition to the polymer melt.

Optionally, a recycle step may be incorporated into the process wherein scrap foam and foam scrap from cutting operations such as edge trimming is recycled back into the foam process after first being reduced to a polymer pellet form using standard plastic recycle compounders. The extrudable composition of the present invention alleviates further build-up of water extractable inorganic by-products produced while stabilizing the halogenated flame retardant in the recycle process and the subsequent re-melting of the recycle pellet in the extruder.

The process parameters may be varied, as would be known by one skilled in the art, to produce foam with the desired cell size and density.

The process of the present invention is useful to produce the foam of the present invention. Foams of the present invention are made by extruding a foamable composition, as described above and characteristically have similar water extractable cation concentrations as described for the foamable compositions, as described above.

Foams of the present invention typically have a density of at 80 kg/m³ or less, preferably 64 kg/m³ or less, more preferably 48 kg/m³ or less. Additionally, foams of the present invention generally have a density of 20 kg/m³ or more. The density desirably is in a range of from 24 kg/m³ to 48 kg/m³ if the foam is to be used for insulation purposes. If the foam is to be used as billet foam, the range is preferably from 24 kg/m³ to 64 kg/m³, and more preferably from 28 kg/m³ to 37 kg/m³.

Foams of the present invention preferably have a unimodal cell size distribution and an average cell size in a range from 0.1 mm to 4.0 mm. If the foam is to be used for insulation purposes, the cell sizes are preferably in the range of from 0.1 mm to 0.8 mm, and more preferably 0.1 mm to 0.5 mm. If the foam is to be used as billet foam, the cell sizes are preferably in the range of from 0.5 mm to 4 mm, and more preferably 0.8 mm to 2.5 mm. The open cell content for foams of this invention can be from 0-100% open. Determine average cell size according to ASTM method D3576. For optimum insulation properties the foam desirably contains 30 percent (%) or less, preferably 10% or less, more preferably 5% or less, and most preferably 2% or less open cell content. Measure open cell content according to ASTM method D6226-05.

Foams of the present invention, if desired, may be laminated to similar foam materials, to films or to rigid facers. Examples of useful films include, but are not limited to those found in U.S. Pat. No. 5,695,870 and U.S. Pat. No. 6,358,599, both of which are hereby incorporated by reference in their entirety. Examples of useful rigid facers include, but are not limited to, concrete, steel, aluminum, gypsum board (commonly known as drywall) and other materials commonly known in the construction industry.

The foams resulting from extrusion of the inventive composition may be used in such areas as building foam insulation, both above and below ground applications, as part of walls and roof assemblies, decorative billet applications, pipe insulation and insulated molded concrete foundation applications. Skilled artisans recognize other uses for such foams as well.

### EXAMPLES

The following examples illustrate, but do not in any way limit, the present invention. Arabic numerals represent examples (Ex) of the invention and letters of the alphabet designate comparative examples (Comp Ex). All parts and percentages are by weight unless otherwise stated. In addition, all amounts shown in the tables are based on weight of polymer contained in the respective compositions unless otherwise stated.

Foam sample density is determined according to ASTM D3575-93, Suffix W, Method A (determine foam volume by linear measurement of a specimen (a 10 centimeter (cm) cross-section that is cut from a foam)), weigh the specimen and calculate apparent density (weight per unit volume)) and foam cell size is determined according to ASTM D3576. Percent open cell content is determined according to ASTM D 6226-98. All of such ASTM procedures being incorporated herein by reference.

### Sample Preparation

Prepare styrene-acrylonitrile (SAN) foams using a 2.5 in. (63 mm) single screw extruder with two additional sequential process zones for mixing and cooling after typical sequential zones for feeding, melting, and metering.

Provide a polymer resin comprising a 50/50 weight ratio blend of a poly(styrene-co-acrylonitrile) (SAN) having 16.5 wt % acrylonitrile, weight average molecular weight (M_{w}) of 83,100 and a polydispersity of 2.15; and a SAN having 15 wt % acrylonitrile, weight average M_{w} of 118,000 and a polydispersity of 2.2. Feed the polymer resin into the extruder at a rate of 90.1 kg/hr (200 lbs/hour). Melt blend the polymer resin with additives in the extruder to form a polymer gel.

Each of the samples contain the following additives: 0.15 pph barium stearate, 0.25 pph talc, 0.3 pph linear low density polyethylene (DOWLEX® 2247G, DOWLEX is a trademark of The Dow Chemical Company) and 0.125 pph of copper phthalate blue concentrate at 20 wt % in polystyrene. Samples may contain additional additives. Table 1 describes the additional additives and Table 2 indicates which samples contain which additional additives. For the additives “pph” refers to weight parts per 100 weight parts resin).

TABLE 1

| Additive | Additive Descriptions |
|---|---|
| Saytex ® HP 900 | Hexabromocyclododecane (HBCD). SAYTEX is a |
| (“HP900”) | trademark of Albemarle Corporation. |
| Great Lakes SP-75 | Available from Chemtura, (95/5 blend of HBCD and |
| (“SP-75”) | hydrotalcite) |
| TSPP | Tetrasodium pyrophosphate, Thermphos Pyro coarse |
| | E 450, Thermphos International B.V. |
| Therm-chek ® 832 | Organotin carboxylate, an oligomeric dibutyl tin |
| (“T-832”) | carboxylate available from Ferro Corporation. |
| | THERM-CHEK is a trademark of Ferro |
| | Corporation. |
| DHT4A | Synthetic hydrotalcite-like compound, |
| (“hydrotalcite”) | [Mg4•3Al₂(OH)12.6CO₃—mH₂0], |
| | available from Kyowa Chemical Industry Co., Ltd. |
| Naugard ® XL-1 | 2,2′-oxamidobis-[ethyl-3-(3,5-di-tert-butyl-4- |
| | hydroxyphenyl)propionate], available from |
| | Chemtura. Serves as an anti-oxidant/chelant. |
| | NAUGARD is a trademark of Chemtura |
| | Corporation. |
| Araldite ECN1273 | Ortho cresol novolac epoxy resin, MW = 1090, |
| | Epoxy Eq. Wt = 225, mp = 73, available from |
| | Huntsman Advance Materials Americas Inc. |

Extrude the polymer gel from the extruder into a mixing. The final section of the extruder barrel had a temperature of 220° C. and the mixing device has a temperature of 200° C. Add blowing agent in the mixing device at pressure of approximately 13.8 mega Pascals (2000 psi) to form a foamable polymer gel. The blowing agent composition is 7.5 pph 1,1,1,2-tetrafluoroethane (HFC-134a), 1.2 pph carbon dioxide and 1.0 pph water, with pph referring to weight parts per 100 weight parts resin. Cool the foamable polymer gel to a temperature of approximately 132° C., extrude through a slit die into atmospheric pressure and allow to expand into a polymeric foam.

Table 3 identifies compositions for samples serving as Comparative Examples (Comp Exs) and Examples (Exs).

TABLE 3

| | | Breakdown of Additive Components Presents | | | | | |
|---|---|---|---|---|---|---|---|
| | | (concentration in weight parts per hundred weight parts polymer) | | | | | |
| | HBCD | | | | Naugard ® | Araldite | |
| Sample | additive | HBCD | T-832 | Hydrotalcite | XL-1 | ECN1273 | TSPP |
| Comp Ex A | HP900 | 0.8 | 0 | 0 | 0 | 0.25 | 0 |
| Comp Ex B | SP-75 | 0.86 | 0 | 0.04 | 0 | 0 | 0 |
| Ex 1 | HP900 | 1.5 | 0 | 0 | 0 | 0.2 | 0 |
| Ex 2 | HP900 | 0.8 | 0.02 | 0.01 | 0.02 | 0 | 0 |
| Ex 3 | HP900 | 0.8 | 0.02 | 0.01 | 0.02 | 0.1 | 0 |

Table 4 presents the foam properties for the samples. The concentration of water extactable cations includes analysis of all Group 1A and 2A cations as well as iron, nickel, zinc and other metal cations. Concentration values are in weight parts per million weight parts polymer.

TABLE 4

| | | | | | | | Total | |
|---|---|---|---|---|---|---|---|---|
| | | | Open | | Die Face | | Water | |
| | Mean | | Cell | Skin | Build | Free | Extractable | Barium |
| Sample | Cell Size | Density | content | Quality | Up?¹ | Bromide | Cations | Cations |
| Comp Ex A | 0.24 | 34.2 | 0 | Horizontal | Yes | 220 | 470 | 470 |
| | | | | cracks on | | | | |
| | | | | both | | | | |
| | | | | primary | | | | |
| | | | | surfaces | | | | |
| Comp Ex B | 0.23 | 33 | 4.4 | Horizontal | Yes | NM² | NM² | NM² |
| | | | | cracks on | | | | |
| | | | | both | | | | |
| | | | | primary | | | | |
| | | | | surfaces | | | | |
| Ex 1 | 0.27 | 34.8 | 0 | Good³ | None | 32 | 25 | 25 |
| Ex 2 | 0.18 | 37.7 | 0 | Good³ | None | 150 | 161 | 147 |
| Ex 3 | 0.24 | 33.2 | 0 | Good³ | None | 47 | 53 | 53 |

¹Discern whether there is die face build up by visual observation of the die face after running eight hours at the process rate of the present samples. Build up of salts on the die face necessarily indicates concomitant build-up on the die lip, which is further confirmed by the skin quality observations.
²NM—not yet measured. Evidence of die build up and poor skin quality is evidence that the hydrotalcite composition generated an unacceptably high level of salts from water extractable cations by failing to solve the die face build up and skin quality problems.
³Good skin quality means the primary surface is absent any defects in the form of lines, cuts, fracture or other irregularities extending in the extrusion direction along a primary surface of the foam as evident with an unaided human eye. The primary surface is also free of irregularities due to blow-holes that rupture through the primary surface.

Comp Ex A illustrates that TSPP, a commonly used acid scavenger-type inorganic stabilizer, is ineffective at eliminating die face and die lip build up and results in high concentrations of water extractable cations.

Comp Ex B illustrates that hydrotalcite, an inorganic clay-based acid scavenger additive, is ineffective at eliminating die face and die lip build up and results in a poor quality skin on the foam surface.

Ex 1 illustrates that even with a doubling of the brominated flame retardant concentration an organo-epoxy acid scavenging stabilizer achieves both a low water extractable cation concentration, a low free bromide concentration and a low barium cation concentration. The organo-epoxy acid scavenging stabilizer solves the problem of die face and die lip build-up and associated poor skin quality, even in view of the higher flame retardant concentration.

Ex 2 illustrates that an innocuous dieneophilic organotin compound (an organotin carboxylate, more specifically, an oligomeric dibutyl tin carboxylate) in combination with a chelating antioxidant solves the problem of avoiding die face and die lip build-up and results in a foam having a good quality foam surface.

Ex 3 illustrates that further adding an organo-epoxy to the composition of Ex 2 dramatically decreases the water extractable cations in the composition—further evidencing the powerful effect of the organo-epoxy compound in achieving a low cation concentration and its effectiveness at avoiding die face and die lip build-up.

1. A process for extruding a thermoplastic polymer foam comprising the steps of:
(a) providing a foamable composition comprising a thermoplastic polymer, a blowing agent that includes water, a brominated flame retardant and a stabilizer in an extrusion die at an initial temperature that exceeds the softening point of the thermoplastic polymer and at an initial pressure sufficient to preclude foaming;
(b) extruding the foamable composition through an extrusion die and out from an extrusion die lip to an environment at a pressure and temperature lower than the initial temperature and pressure; and
(c) allowing the foamable composition to expand into a polymeric foam;
wherein the foamable composition contains 180 weight parts or less of water extractable cations.

2. The process of claim 1, wherein the foamable composition contains 200 weight parts or less free bromide ion per million weight parts of foamable composition.

3. The process of claim 1, wherein the foamable composition contains water extractable Group 2A cations and the concentration of water extractable Group 2A cations is 150 weight parts or less, where weight parts are based on total thermoplastic polymer weight, and the water extractable Group 2A cations account for 80% or more by weight of all water extractable cations in the foamable composition.

4. The process of claim 1, wherein at least 50 percent by weight of the stabilizer is one or more stabilizer selected from a group consisting of innocuous epoxy containing organic compounds, innocuous allylophilic organotin compounds and innocuous dieneophilic organotin compounds.

5. The process of claim 1, wherein at least 50 percent by weight of the stabilizer is one or more innocuous epoxy containing organic compound.

6. The process of claim 5, wherein the innocuous epoxy containing organic compound is epoxy cresol novolac.

7. The process of claim 1, wherein at least 80 percent by weight of the stabilizer is one or more innocuous epoxy containing organic compound.

8. The process of claim 1, wherein the stabilizer is one or more innocuous epoxy containing organic compound.

9. The process of claim 1, wherein the stabilizer is present at concentration of 30 weight-percent or less based on brominated flame retardant weight.

10. The process of claim 1, wherein the concentration of water is at least 0.15 parts per hundred based on polymer weight.

11. The process of claim 1, wherein the thermoplastic polymer comprises one or a combination of more than one alkenyl aromatic polymer.

12. An extruded thermoplastic polymer foam comprising a thermoplastic polymer composition having defined therein multiple cells, the thermoplastic polymer foam containing at least one thermoplastic polymer, a brominated flame retardant, an epoxy containing organic compound and 180 weight parts or less of water extractable cations.

13. The polymer foam of claim 12, wherein the organo-epoxy containing compound is epoxy cresol novolac.

14. The polymer foam of claim 12, wherein the polymer foam further contains less than 200 weight parts free bromide per million weight parts of polymer foam.

15. The polymer foam of claim 12, wherein the thermoplastic polymer comprises one or a combination of more than one alkenyl aromatic polymer.
